(19) United States
(12) Patent Application Publication
(10) Pub. No.: US 2006/0192175 A1
(43) Pub. Date: Aug. 31, 2006

(54) Low viscosity copper solvent extraction reagent formulations

(76) Inventors: R. Brantley Sudderth, Tucson, AZ (US); Stephen M. Olafson, Tucson, AZ (US); Phillip L. Mattison, Columbia Heights, MN (US); Michael J. Virnig, Tucson, AZ (US)

Correspondence Address: COGNIS CORPORATION;PATENT DEPARTMENT, 300 BROOKSIDE AVENUE, AMBLER, PA, 19002, US

(21) Appl. No.: 11/416,573

(22) Filed: May 3, 2006

Related U.S. Application Data
(63) Continuation of application No. 10/996,207, filed on Nov. 23, 2004.
Application No. 10/996,207 is a continuation of application No. 10/657,786, filed on Sep. 8, 2003, now abandoned.
(60) Provisional application No. 60/413,851, filed on Sep. 26, 2002.

(51) Int. Cl. C01B 31/16

(52) U.S. Cl. 252/184

(57) ABSTRACT

A low viscosity water insoluble extraction reagent composition according to the invention is comprised of: (a) an extractant selected from the group consisting of an aldoxime, a ketoxime, or a combination thereof; (b) an equilibrium modifier having a Brookfield viscosity of equal to or less than about 5 centapoise at 25° C. and a flash point equal to or greater than about 141° F. wherein the molar ratio of modifier to extractant is from about 0.05 to about 2.0 so as to provide a net copper transfer greater than that achieved in the absence of modifier. Such low viscosity extractants afford higher recoveries of copper, permit reduced equipment size such as smaller mixers and settlers and the use of reduced amounts of less overall organic inventory.

### CROSS-REFERENCE TO RELATED APPLICATIONS

This application claims priority under 35 U.S.C. §120, and is a continuation of co-pending U.S. patent application No. 10/996,207, filed Nov. 23, 2004, which, in turn, claims priority under 35 U.S.C. §120, and is a continuation of U.S. patent application No. 10/657,786, filed Sept. 8, 2003 (now abandoned), which, in turn, claimed priority under 35 U.S.C. §119(e), of U.S. Provisional Application No. 60/413,851, filed September 26, 2002 (now expired), the entire contents of each of the aforementioned patent applications being incorporated herein by reference.

### BACKGROUND OF THE INVENTION

It is well known that copper can be extracted from aqueous solutions containing the metal in the form of, for example, a sulphate salt by contacting the aqueous solution with a solution of an o-hydroxyaryloxime in a water immiscible organic solvent and then separating the solvent phase loaded with metal, i.e. containing a part of the metal in the form of a chelate compound with the o-hydroxyaryloxime. The metal can then be recovered from the metal loaded solvent phase by stripping with acid solutions followed, for example, by electrowinning. The advantage of high copper extraction shown by these strongly chelating oximes is to some extent offset by the large amount of copper which remains as chelate in the solvent after stripping with acid of convenient strength. While this residual copper as chelate is not lost since it can be recycled to the extraction stage, a reduction in the amount of residual copper chelate would, in the absence of any comparable reduction in the degree of copper extraction from the aqueous solution, afford an improvement in the overall efficiency of the process. It is well known that the amount of copper removed from the solvent phase in the stripping stage is significantly increased if the solvent phase contains a modifier.

Nonylphenol (NP), was one of the earliest modifiers and was used in combination with 5-nonylsalicylaldoxime (NSO). Alcohols, such as isotridecyl alcohol (TDA) have also been used as modifiers in combination with 5-dodecylsalicylaldoxime. Highly branched alcohols and esters, such as 2,2,4-trimethyl-1,3-pentanediol di-isobutyrate (TXIB), have also been used as modifiers as have linear esters such as di-n-butyl adipate (DBA).

Many contemporary solvent extraction plants for copper recovery employ “modified” aldoxime reagents as the copper extractant. A limiting factor in the design and operation of a solvent extraction plant is the viscosity of the reagent. As the reagent concentration increases, the viscosity of the organic phase in the circuit also increases. As viscosity of the organic phase increases, increased energy is required to obtain satisfactory mixing with the aqueous phase and at the same time, phase separations become poorer. Poorer phase separation results in increased entrainment of the organic phase in the exiting aqueous phase as well as aqueous entrainment in the exiting organic phase. Entrainment of organic in the exiting aqueous results in loss of the organic from the circuit and represents a substantial operating cost. Entrainment of aqueous leach solution in the copper loaded organic phase results in transfer of contaminants, such as, iron, manganese, chloride, and nitrate from the leach solution into the tankhouse electrolyte. To control the buildup of iron and other contaminates in the electrolyte, a portion of the electrolyte must be bled from the tankhouse resulting in significant costs for lost copper, acid, cobalt, and other tankhouse additives contained in the bleed. Entrainment of electrolyte in stripped organic results in transfer of electrolyte to extraction. The transfer of electrolyte to extraction lowers the pH of the aqueous phase in extraction making it more difficult to extract the copper resulting in overall poorer recovery of copper in extraction.

As a practical limit with current commercially available extractants, the practical extractant concentration limit for extractants containing aldoximes in combination with modifiers, or modified aldoximes, that can be employed is approximately 30% (v/v) reagent (˜17 gpl Cu loading, 0.53M reagent concentration). Increasing the size of the settlers enables one to run at higher reagent concentrations but this results in significantly higher capital costs for the settlers and necessitates an increase in the overall organic inventory in the plant to fill the settlers.

The use of a lower viscosity extractant would allow higher reagent concentrations in the organic phase. This would allow one to achieve higher recoveries of copper from the aqueous leach solution by providing more reagent to carry out extraction while still maintaining good physical behavior in terms of phase separation. Since the organic phase could transfer more copper, the solvent extraction plant could also be built with smaller mixers and settlers resulting in a substantial savings in capital costs for the plant. Reducing the size of the settlers also results in less overall organic inventory being required to operate the plant.

### BRIEF SUMMARY OF THE INVENTION

It has been found that lower viscosity solvent extraction reagents according to the invention afford a number of advantages such as minimizing entrainment of aqueous in the loaded organic, higher recoveries of copper, reduced equipment size such as smaller mixers and settlers and less overall organic inventory being required to operate a commercial plant. Minimizing entrainment of aqueous in the loaded organic is important when working with typical leach liquors. The leach liquors typically contain other species such as Fe and Mn which transfer to the electrolyte as entrainment and which interfer with electrowinning of high quality copper. Normally, to control the level of these contaminants in electrowinning, a portion of the electrolyte must be removed as a bleed stream resulting in increased costs for sulfuric acid and electrowinning additives such as cobalt, smoothing agents, and acid mist control agents.

A low viscosity water insoluble extraction reagent composition according to the invention is comprised of: (a) an extractant selected from the group consisting of an aldoxime, a ketoxime, or a combination thereof; (b) an equilibrium modifier having a Brookfield viscosity of equal to or less than about 5 centapoise at 25° C. and a flash point equal to or greater than about 141° F. wherein the molar ratio of modifier to extractant is from about 0.05 to about 2.0 so as to provide a net copper transfer greater than that achieved in the absence of modifier.

Another aspect of the invention pertains to a process for recovery of copper from an aqueous solution containing copper values comprising (1) contacting the aqueous solution with an organic phase comprising a water insoluble and water immiscible solvent solution of an extraction reagent composition comprising: (a) an extractant selected from the group consisting of an aldoxime, a ketoxime, or a combination thereof; (b) an equilibrium modifier having a Brookfield viscosity of equal to or less than about 5 centapoise at 25° C. and a flash point equal to or greater than about 141° F. wherein the molar ratio of modifier to extractant is from about 0.05 to about 2.0 so as to provide a net copper transfer greater than that achieved in the absence of modifier; (2) separating the resultant copper pregnant organic phase from the resultant copper barren aqueous phase; and (3) recovering the copper values from the copper pregnant organic phase.

Yet another aspect of the invention pertains to a method of making a low viscosity extraction reagent comprising adding to an extractant selected from the group consisting of an aldoxime, a ketoxime or a combination thereof a modifier having a Brookfield viscosity of equal to or less than about 5 centapoise at 25° C. and a flash point equal to or greater than about 141° F. wherein the molar ratio of the modifier to the extractant of from about 0.05 to about 2.0 so as to provide a net copper transfer greater than that achieved in the absence of modifier, and up to about 20% by weight of a kinetic additive.

### BRIEF DESCRIPTION OF THE SEVERAL VIEWS OF THE DRAWINGS

Not applicable.

### DETAILED DESCRIPTION OF THE INVENTION

An equilibrium modifier according to the invention is any organic compound capable of forming hydrogen bonds with the extractant and having a Brookfield viscosity at 25° C. of less than about 5.0 centipoise and a flash point equal to or greater than about 141° F. (60.6° C.). Preferably, the modifiers according to the invention are selected from the group consisting of: alcohols, carboxylic acid esters, oximes, nitrites, ketones, amides, carbamates, sulfoxides, ureas, and phosphine oxides having a Brookfield viscosity at 25° C. of less than about 5.0 centipoise and a flash point equal to or greater than about 141° F. (60.6° C.). Examples of such modifiers are disclosed in U.S. Pat. No. 6,231,784, the entire contents of which are incorporated herein by reference. The most preferred classes of modifiers are nitrites, ether nitrites, di-alkyl ethers, ketones, esters, and alcohols. The molar ratio of modifier to extractant is from about 0.05 to about 2.0 and preferably from about 0.2 to about 1.5 and most preferably from about 0.3 to about 1.25.

Optionally, kinetic additives can be used in the compositions according to the invention and are α-hydroxy oximes or α,β-dioximes or a combination thereof. A preferred α-hydroxy oxime kinetic additive is 5,8-diethyl-7-hydroxy dodecane-6-oxime and a preferred dioxime kinetic additive is a mixture of 1—(4′-alkylphenyl)-1,2-propanedione dioximes. α-hydroxy oximes are disclosed in U.S. Pat. Nos. 4,507,268 and 3,224,873 while α,β-dioximes are disclosed in U.S. Pat. No. 4,173,616. The dioxime mixtures are disclosed in U.S. Pat. No. 4,176,616. The entire contents of each of the above patents is incorporated herein by reference. The kinetic additive can be present in an amount of up to about 20% by weight of the composition.

The extractant compositions comprised of the modifiers according to the invention typically drain from a shipping container such as an isotainer or a tote at a faster rate and more completely especially at lower temperatures. Many mines add reagent to the circuit by directly draining a tote into the circuit. Faster drain times translate into lower manpower requirements for handling, less wastage, and less potential for exposure of the environment to the extractant, since the containers empty more completely.

In solvent extraction circuits, the extractant compositions comprised of the modifiers according to the invention require less energy to mix the organic phase with the aqueous phase and to pump the organic phase. For example, phase separations are improved resulting in less transfer of aqueous from extraction to stripping as entrainment in the loaded organic and from stripping to extraction in the stripped organic, especially at higher reagent concentrations. There is also less entrainment of organic in aqueous raffinate exiting the circuit resulting in less reagent consumption per pound of copper produced.

Since the extractant compositions comprised of the modifiers according to the invention can be used at higher concentrations in a circuit and still maintain good physical performance in terms of entrainment, the overall size of the settlers can be reduced. This reduces the amount of capital expense required to build the plant. It also reduces the volume of organic phase required to fill the plant resulting in additional savings. Installing a mixer settler in a modern plant costs about US $400 per square foot of settler area on a fully prepared site. Typical modern solvent extraction plants have settlers measuring about 90 feet long by 90 feet wide. The cost of such a unit is approximately US $3.24 MM. If the reagent concentration with the new formulations can be increased by 25% over current existing reagents, flows could be reduced accordingly and the settlers could be reduced by the same amount resulting in an overall savings of US $0.8 MM per settler. For a typical plant having 2 extraction stages, a wash stage, and 2 strip stages, the overall capital cost savings would be US $4.0 MM.

The following examples are meant to illustrate but not to limit the invention.

### EXAMPLE 1

To demonstrate the advantages of new formulations with regard to kinetics, a series of experiments were carried out in the following fashion.

Reagent A was prepared by dissolving 5-nonylsalicylaldoxime (NSO) and 2,6,8-trimethyl-4-nonanone in SHELLSOL® D70 (Hydrocarbon diluent available from Shell Oil Co.) to give a solution that was 1.76 M in NSO and 1.88 M (346 gpl) in 2,6,8-trimethyl-4-nonanone. Reagent B was prepared in a similar fashion to give 1.76 M in NSO and 0.76 M (196 gpl) in di-n-butyl adipate in SHELLSOL® D70. The viscosity of di-n-butyl adipate was 5.3 centapoise as compared to 2.4 centapoise for 2,6,8-trimethyl-4-nonanone as determined with a Brookfield viscometer using a #18 spindle at 60 RPM at 25° C. Solutions of both Reagent A and Reagent B were prepared at 20% (v/v) in CONOSOL® 170E (a petroleum distillate solvent available from Conoco-Phillips Inc.) to give Solution A and Solution B respectively. These solutions were contacted by shaking for 2 minutes in a separatory funnel at an O/A=1 with an aqueous phase containing 35 gpl Cu(II) as the sulfate and 160 gpl sulfuric acid in DI water to give a stripped organic. The aqueous phase was discarded and the organic phases were assayed for copper by atomic absorption spectroscopy. The aqueous phase was prepared to contain 6 gpl Cu(II), 3 gpl Fe(IIl) all as the sulfates in DI water adjusted to pH 2.00 with sulfuric acid.

The kinetic tests were carried out using the procedure described in Example 3. The starting organics were the stripped organics prepared above. Tests were carried out with both aqueous continuous and organic continuous mixing. Mixer rpm was set at 1750 rpm in one series and 875 rpm in the other. Samples of emulsion were removed at 15, 30, 60, 90, 120, and 300 second intervals. The phases were allowed to separate and the aqueous was discarded. The organic was filtered through phase separation paper and then assayed for copper by atomic absorption spectroscopy. The results are summarized in the following Table.

| | 1750 | | | | 875 | | | |
|---|---|---|---|---|---|---|---|---|
| | Solution A | | Solution B | | Solution A | | Solution B | |
| | (gpl Cu) | | (gpl Cu) | | (gpl Cu) | | (gpl Cu) | |
| Continuity | Org | Aq | Org | Aq | Org | Aq | Org | Aq |
| Strip Org | 2.52 | 2.52 | 2.96 | 2.96 | 2.52 | 2.52 | 2.96 | 2.96 |
| 15 sec | 6.80 | 7.18 | 7.59 | 7.59 | 5.43 | 4.21 | 5.07 | 4.07 |
| 30 sec | 7.23 | 7.55 | 7.89 | 8.07 | 6.48 | 5.94 | 6.27 | 6.03 |
| 60 sec | 7.55 | 7.64 | 8.17 | 8.15 | 7.23 | 7.09 | 7.39 | 7.31 |
| 90 sec | 7.65 | 7.70 | 8.20 | 8.21 | 7.55 | 7.43 | 7.84 | 7.75 |
| 120 sec | 7.69 | 7.68 | 8.19 | 8.21 | 7.62 | 7.61 | 8.02 | 7.99 |
| 300 sec | 7.72 | 7.69 | 8.28 | 8.24 | 7.63 | 7.66 | 8.13 | 8.14 |

Percent extraction was calculated as follows:
(([Cu]_{X sec} − [Cu]_{Strip Org})/([Cu]_{300 sec} − [Cu]_{Strip Prg})) × 100 = % extraction

The data in terms of % extraction is summarized in the following Table.

| | 1750 | | | | 875 | | | |
|---|---|---|---|---|---|---|---|---|
| | Solution A | | Solution B | | Solution A | | Solution B | |
| | (%) | | (%) | | (%) | | (%) | |
| Continuity | Org | Aq | Org | Aq | Org | Aq | Org | Aq |
| 15 sec | 83 | 90 | 87 | 88 | 57 | 33 | 41 | 21 |
| 30 sec | 91 | 97 | 93 | 98 | 77 | 67 | 64 | 59 |
| 60 sec | 97 | 99 | 98 | 98 | 92 | 89 | 86 | 84 |
| 90 sec | 99 | 100 | 98 | 99 | 98 | 96 | 94 | 92 |
| 120 sec | 99 | 99 | 98 | 99 | 100 | 99 | 98 | 97 |

Typical tip speeds in a commercial mixer are in the range of 800 to 1000 feet per minute in order to insure an adequate emulsion to achieve good extraction kinetics. An rpm of 1750 rpm corresponds to a tip speed of 802 feet per minute and 875 rpm corresponds to a tip speed of 401 feet per minute. As can be seen from the data, both formulations show excellent extraction kinetics at the higher rpm (tip speed). Surprisingly at the lower rpm (lower tip speed and lower power input into the mixer), the formulation based on 2,6,8-trimethyl4-nonanone (Solution A) demonstrates significantly faster extraction kinetics than does the formulation based on di-n-butyl adipate (Solution B).

### EXAMPLE 2

To compare the effects of using a low viscosity modifier; 2,6,8-trimethyl-4-nonanone, with those of using a high viscosity modifier; 2,2,4-trimethyl-1,3-pentanediol di-isobutyrate (TXIB), a series of circuit runs were carried out in a continuous laboratory solvent extraction mini-plant using 180 ml mixer boxes/396 ml settlers. The circuit consisted of 3 stages of extraction in series and 2 stages of stripping in series. The loaded organic line exiting E₁ was fitted with a three way valve so that samples of the loaded organic could be collected directly as the organic exited the stage.

The organic phases consisted of either LIX® 6422N-LV, 5-nonylsalicylaldoxime modified with 2,6,8-trimethyl4-nonanone, or ACORGA® M5640, 5-nonylsalicylaldoxime modified with TXIB, diluted to 45% (vol/vol) in Phillips ORFOM® SX-7. Both reagents were formulated to contain 1.76-1.8 M 5-nonylsalicylaldoxime with sufficient modifier to give a strip point of 1.8 gpl Cu when equilibrated with a synthetic electrolyte containing 35 gpl Cu and 160 gpl sulfuric acid at concentration of 10% (vol/vol). The copper max load of the organics was 25.2 gpl versus a feed containing 6 gpl Cu/3 gpl Fe(III), pH 2.0 as determined by the test method of Example 3.

The viscosities of the “as formulated” reagents and the circuit organic are summarized in the following Table.

| | “As formulated” | 45% (vol/vol) Reagent | |
|---|---|---|---|
| Reagent | (cSt) | @ 25° C. (cSt) | @ 45° C. (cSt) |
| LIX ® 6422N-LV | 31 | 6.17 | 4.04 |
| ACORGA ® | 90 | 7.14 | 4.62 |
| M5640 | | | |

The organic phase prepared from the ACORGA® M5640, which uses TXIB as modifier, was approximately 15% more viscous than that prepared from the LIX® 6422N-LV.

The circuit data is summarized in the following Table. The feed was a synthetic copper solution containing 14 gpl Cu, 14 gpl sulfuric acid, and 33 gpl total Fe (2 gpl Fe(III)). The barren strip solution was a synthetic strip solution containing 33 gpl Cu and 200 gpl sulfuric acid. In stripping, the Cu content of the aqueous was increased from 33 gpl to 46.7 gpl in both cases. The same circuit was used in both trials. The agitation was maintained constant in all stages during both runs. The entrainment of the aqueous in the loaded organic was determined by carefully collecting a 100 ml sample of the loaded organic using the t-valve previously described into a calibrated glass vessel (Tube, centrifuge, oil, 100 ml available from Kimble Glass). The organic was then centrifuged for 30 minutes at 2500 rpm. The volume of aqueous in the loaded organic was then read directly and used to calculate the entrainment in ppm.

| | | | | | Aq |
|---|---|---|---|---|---|
| | Flow Rates | | | | entrained |
| | Org | Aq | Raffinate | % Cu | in LO |
| Reagent | (ml/min) | (ml/min) | (gpl Cu) | Recovery | (ppm) |
| LIX ® | 33.9 | 26.4 | 0.73 | 94.8 | 450 |
| 6422N-LV | | | | | |
| ACORGA ® | 34.1 | 25.6 | 0.72 | 94.8 | 700 |
| M5640 | | | | | |

As shown in the Table immediately above, the two reagents performed essentially identically with regard to copper recovery. The ACORGA® M5640, which uses the more viscous TXIB as modifier, entrained approximately 50% more aqueous in the loaded organic as did the LIX® 6422N-LV, which uses the less viscous 2,6,8-trimethyl-4-nonanone as modifier.

### EXAMPLE 3

### Quality Control Test for LIX® Oxime Reagents

### EQUIPMENT AND REAGENTS

TEST VESSEL: The test vessel was a PVC box I.D. 3½×3½×6 inches (8.9 ×8.9 ×15.4 cm), clean and free of soap or detergent residue. The polypropylene impeller was 1.75 inches (4.45 cm) in diameter with 6 slots, 0.125 inches (0.32 cm) deep and 0.125 inches wide, the top of the hub was 1 cm above the top of the impeller, and the shaft was 316L stainless steel, 23 cm long. The mixer speed was adjusted to 1750±25 rpm using Stirrer Type RZRI available from Caframo (Wiarton, Ontario, Canada NOH 2T0).

SAMPLE DEVICE: When sampling the emulsion it is important that no additional mixing occur. A large bore sampling tube should be used. A 10 ml volumetric pipette with the tip cut off or a 10 ml serological pipette with the sample drawn through the large end are satisfactory devices.

### ORGANIC PHASE PREPARATION

A. FOR NORMAL FORMULATED LIX® REAGENTS: Prepare a 500 ml solution of exactly 10 v/v % LIX® reagent in the diluent Escaid 100 or its approved equivalent. If v/v dilution is not convenient, w/v dilutions can be calculated and made using the density of the LIX® reagent lot being tested.

B. FOR CONCENTRATE REAGENTS EXCEPT LIX® 860-IC: Prepare a 500 ml solution of exactly 7.143 v/v % LIX® reagent in the diluent Escaid 100 or its approved equivalent. If v/v dilution is not convenient, w/v dilutions can be calculated and made using the density of the LIX® reagent lot being tested.

C. FOR LIX® 860-IC: Prepare a 500 ml solution of exactly 8.00 v/v % LIX® 860-IC in the diluent Escaid 100 or its approved equivalent. If v/v dilution is not convenient, w/v dilutions can be calculated and made using the density of the LIX® reagent lot being tested.

### AQUEOUS PHASE PREPARATION

STANDARD EXTRACTION AQUEOUS PHASE: The extraction aqueous phase contains 6±0.1 gl Cu^{+2,} 3±0.1 gl Fe⁺³ (both as sulfates) at a pH of 2.0 ±0.1.

STANDARD STRIP AQUEOUS PHASE: The strip aqueous phase contains 35 ±0.7 g/l Cu (as the sulfate) and 160 ±2 g/l H₂SO₄.

All solutions were prepared from reagent grade chemicals dissolved in D.I. water.

All solution temperatures were equilibrated to 23±1° C. before use.

Before and after each test all equipment should be rinsed several times with DI water followed by methanol or acetone and completely dried before each use. Failure to adequately rinse and dry the equipment can result in erroneous results.

### EXTRACTION KINETICS, EXTRACTION ISOTHERM POINT, EXTRACTION PHASE SEPARATION AND EXTRACTION Cu/Fe SELECTIVITY

Vigorously contact 400 ml of the organic phase with 400 ml of strip aqueous phase for two minutes in a separatory funnel. After the phases have separated, filter the organic phase through Whatman 1PS or equivalent filter paper. Add 350 ml of filtered organic into the test vessel and adjust the impeller so that it is centered in the test vessel and the top of the polypropylene hub of the impeller is at the surface level of the organic phase. Start the stirrer and adjust the impeller speed to 1750 ±25 rpm and then over 5 seconds smoothly add 350 ml of the extraction aqueous phase. Start the stopwatch immediately at the end of the aqueous addition.

For all LIX® reagents except LIX® 84, LIX® 84N, LIX® 84-1 and LIX® 84-IC, a 30 second kinetic sample (E₃₀) is taken as follows: Starting at 29 seconds, smoothly remove 10-15 ml of sample emulsion from the top 2 cm of the test vessel and transfer the sample into a small beaker or separatory funnel. After the phases have separated, filter the organic sample through Whatman 1PS or equivalent filter paper, label as the E₃₀ sample and save for analysis. Continue mixing for a total of 300 seconds at which time the stirrer is stopped. Immediately start a stopwatch and determine the time required for complete separation of the phases. Phase separation is considered complete when only a monolayer of bubbles remains at the interface. Sample the organic phase, filter the organic sample through Whatman 1PS or equivalent filter paper, label as the E₃₀₀ sample and save for analysis. Refer to the copper aqueous and organic procedures for analysis. For LIX® 84, LIX® 84N, LIX® 84-1 and LIX® 84-IC, a 60 second kinetic sample (E₆₀) was taken as follows: Starting at 59 seconds, smoothly remove 10-15 ml of sample emulsion from the top 2 cm of the test vessel and transfer the sample into a small beaker or separatory funnel. After the phases have separated, filter the organic sample through Whatman 1PS or equivalent filter paper, label as the E₆₀ sample and save for analysis. Continue mixing for a total of 300 seconds at which time the stirrer is stopped. Immediately start a stopwatch and determine the time required for complete separation of the phases. Phase separation is considered complete when only a monolayer of bubbles remains at the interface. Sample the organic phase, filter the organic sample through Whatman 1PS or equivalent filter paper, label as the E₃₀₀ sample and save for analysis. Refer to the copper aqueous and organic procedures for analysis.

### STRIP KINETICS, STRIP ISOTHERM POINT AND STRIP PHASE SEPARATION

The organic and aqueous phases from the extraction test above were transferred to a separatory funnel and the phases allowed to completely separate. The aqueous phase was withdrawn and discarded. Loaded organic (325 ml) is carefully transferred to a graduated cylinder making sure no aqueous transfers with the organic. The strip aqueous (325 ml) is added to a clean test vessel. Adjust the impeller height as previously described, start the stirrer and adjust the speed to 1750 25 rpm. Over a period of 5 seconds add the loaded organic. Start the stopwatch immediately after the addition of the organic. Starting at 29 seconds, smoothly remove 10 - 15 ml of sample emulsion from the top 2 cm of the test vessel and drain into a small beaker or separatory funnel. Filter the organic phase through Whatman 1PS paper or equivalent and label as the S₃₀ sample. Continue stirring for a total of 300 seconds, stop the stirrer and allow the phases to separate measuring the phase separation time as previously described. Sample the organic phase, filter the organic sample through Whatman 1PS or equivalent filter paper, label as the S₃₀₀ sample and save for analysis. Refer to the copper aqueous and organic procedures for analysis.

### MAXIMUM COPPER LOADING

Take an aliquot of the diluted LIX® reagent and an equal volume of standard extraction aqueous and contact them vigorously for 2 minutes in a separatory funnel. Allow the phases to separate and discard the aqueous phase. Add fresh standard extraction aqueous and repeat the contact. Continue until a total of 4 contacts have been made. After the last contact, filter the organic sample through Whatman 1PS or equivalent filter paper, label as the Max

Load sample and save for analysis.

Organic samples E₃₀ or E₆₀, E₃₀₀, S₃₀ and S₃₀₀ and the Max Load sample were assayed by Atomic Absorption Spectroscopy (AAS) for Cu. The E₃₀₀ sample is also assayed by MS for Fe. All results were expressed in units of g/L.

CALCULATIONS

1. Extraction isotherm point, Cu =E₃₀₀

2. Strip isotherm point, Cu =S₃₀S₃₀₀

$$\% = \frac{{E}_{30}}{{E}_{300}} \times 100 or$$

$$\frac{{E}_{60}}{{E}_{300}} \times 100$$

3. Extraction kinetics,

$$= \frac{{E}_{300} ( Cu )}{{E}_{300} ( Fe )}$$

4. Extraction Cu/Fe selectivity

$$\% = \frac{{E}_{300} ( Cu ) - {S}_{30} ( Cu )}{{E}_{300} ( Cu ) - {S}_{300} ( Cu )} \times 100$$

5. Strip Kinetics,
6. Net Transfer,
Cu =E₃₀₀ - S₃₀₀

What is claimed is:

1. A water insoluble extraction reagent composition comprising:
(a) an extractant selected from the group consisting of an aldoxime, a ketoxime, or a combination thereof;
(b) an equilibrium modifier selected from the group consisting of nitrites, ether nitriles, di-alkyl ethers, esters, and alcohols and having a Brookfield viscosity of equal to or less than about 5 centapoise at 25° C. and a flash point equal to or greater than about 141° F. wherein the molar ratio of modifier to extractant is from about 0.05 to about 2.0 so as to provide a net copper transfer greater than that achieved in the absence of modifier.

2. The composition of claim 1 wherein the extractant is selected from 5-nonylsalicylaldoxime, 5-dodecylsalicylaldoxime, 5-octylsalicylaldoxime, 5-heptylsalicylaldoxime, 2-hydroxy-5-nonylacetophenone oxime and mixtures thereof.

3. The composition of claim 1 wherein the modifier has a viscosity of 2.4 centipoise at 25° C.

4. A method for improving the extraction of copper from an aqueous solution containing copper values with lower mixer power input in the extraction stage where the aqueous solution is contacted with an organic phase comprising a water insoluble and water immiscible solvent solution of an extraction reagent composition containing an extractant selected from the group consisting of an aldoxime, a ketoxime, or a combination thereof and an equilibrium modifier, the method comprising using an equilibrium modifier having a Brookfield viscosity of equal to or less than 5 centapoise at 25° C. and a flash point equal to or greater than 141 F., wherein the molar ratio of modifier to extractant is from 0.05 to 2.0 so as to provide a net copper transfer greater than that achieved in the absence of modifier.

5. The method of claim 4 wherein the modifier is selected from the group consisting of: alcohols, carboxylic acid esters, oximes, nitriles, ketones, amides, carbamates, sulfoxides, ureas, and phosphine oxides.

6. The method of claim 4 wherein the modifier is selected from the group consisting of nitrites, ether nitriles, di-alkyl ethers, ketones, esters, and alcohols.

7. The method of claim 4 wherein the extraction reagent composition is further comprised of an α-hydroxy oxime, an α,β-dioxime or a combination thereof as a kinetic additive.

8. The method of claim 4 wherein the extractant is selected from 5-nonylsalicylaldoxime, 5-dodecylsalicylaldoxime, 5-octylsalicylaldoxime, 5-heptylsalicylaldoxime, 2-hydroxy-5-nonylacetophenone oxime and mixtures thereof.

9. The method of claim 4 wherein the modifier has a viscosity of 2.4 centipoise at 25° C.

10. The method of claim 4 wherein the modifier is 2,6,8-trimethyl4-nonanone.

11. A method of improving the flow and mixing characteristics of an extraction reagent comprising an oxime extractant and an equilibrium modifier, the method comprising adding to an extractant selected from the group consisting of an aldoxime, a ketoxime or combination thereof a modifier having a Brookfield viscosity of equal to or less than 5 centapoise at 25° C. and a flash point equal to or greater than 141° F., wherein the molar ratio of modifier to extractant is from 0.05 to 2.0 so as to provide a net copper transfer greater than that achieved in the absence of modifier.

12. The method of claim 11 wherein the modifier is selected from the group consisting of: alcohols, carboxylic acid esters, oximes, nitrites, ketones, amides, carbamates, sulfoxides, ureas, and phosphine oxides.

13. The method of claim 11 wherein the modifier is selected from the group consisting of nitrites, ether nitrites, di-alkyl ethers, ketones, esters, and alcohols.

14. The method of claim 11 wherein the extraction reagent composition is further comprised of an α-hydroxy oxime, an α,β-dioxime or a combination thereof as a kinetic additive.

15. The method of claim 11 wherein the equilibrium modifier has a viscosity of 2.4 centipoise at 25° C.

16. The method of claim 11 wherein the modifier is 2,6,8-trimethyl-4-1 5 nonanone.

17. The method of claim 11 wherein the extractant is selected from 5-nonylsalicylaldoxime, 5-dodecylsalicylaldoxime, 5-octylsalicylaldoxime, 5-heptylsalicylaldoxime, 2-hydroxy-5-nonylacetophenone oxime and mixtures thereof.

18. A method of reducing the entrainment of the aqueous phase in the organic-extractant phase in a copper recovery process in which an equilibrium modifier is used with an oxime extractant reagent, comprising adding to an extractant selected from the group consisting of an aldoxime, a ketoxime or a combination thereof, a modifier having a Brookfield viscosity of equal to or less than 5 centapoise at 25° C. and a flash point equal to or greater than 141 F. wherein the molar ratio of modifier to extractant is from 0.05 to 2.0 so as to provide a net copper transfer greater than that achieved in the absence of modifier.

19. The process of claim 18 wherein the modifier is selected from the group consisting of: alcohols, carboxylic acid esters, oximes, nitrites, ketones, amides, carbamates, sulfoxides, ureas, and phosphine oxides.

20. The process of claim 18 wherein the modifier is selected from the group consisting of nitrites, ether nitrites, di-alkyl ethers, ketones, esters, and alcohols.

21. The method of claim 18 wherein the modifier has a viscosity of 2.4 centipoise at 25° C.

22. The method of claim 18 wherein the modifier is 2,6,8-trimethyl-4-nonanone.

23. The method of claim 18 wherein the extractant is selected from 5-nonylsalicylaldoxime, 5-dodecylsalicylaldoxime, 5-octylsalicylaldoxime, 5-heptylsalicylaldoxime, 2-hydroxy-5-nonylacetophenone oxime and mixtures thereof.
